(19) United States
(12) Patent Application Publication
(10) Pub. No.: US 2015/0108137 A1
(43) Pub. Date: Apr. 23, 2015

(54) Pressure Vessel and a Method of Loading CNG into a Pressure Vessel

(71) Applicants: Francesco Nettis, London (GB); Giulio Carini, Luxembourg (LU); Vanni Neri Tomaselli, Luxembourg (LU)

(72) Inventors: Francesco Nettis, London (GB); Giulio Carini, Luxembourg (LU); Vanni Neri Tomaselli, Luxembourg (LU)

(73) Assignee: Blue Wave Co S.A., Luxembourg (LU)

(21) Appl. No.: 14/363,099

(22) PCT Filed: Dec. 5, 2011
(86) PCT No.: PCT/EP2011/071791

§ 371 Date: Oct. 24, 2014

(51) Int. Cl. F17C 5/06

(52) U.S. Cl. CPC F17C 5/06
USPC 220/560.04; 141/4

(57) ABSTRACT

A pressure vessel for storage and transportation of CNG comprises a body, which defines an internal volume in which the CNG is stored and transported. An inlet is provided through which the CNG can be loaded into the internal volume of the vessel. At the end of said inlet there is a CNG expansion section through which the CNG expands into the vessel when loaded. The pressure vessel further comprises a CNG loading appendage for injecting the CNG at a point inside the internal volume of the vessel, thereby increasing the space between the expansion point of the CNG and the walls of the vessel.

The present invention relates to a pressure vessel and a method of loading compressed natural gas (CNG) into a pressure vessel. Once loaded the CNG can be stored within the pressure vessel or transported therein to other locations.

CNG is a form of natural gas, typically a raw natural gas, whereby it can be stored and transported, while in that compressed state (potentially at pressures of between 200 and 300 bar at room temperature (20° C.), i.e. typically at around 250 bar), within a volume that occupies a very small fraction of the volume it would occupy as a gas at atmospheric pressure. Typically the volume reduction is about 99%, i.e. it occupies perhaps only 1% or less of the volume it would occupy as a gas at atmospheric pressure. The transportation of CNG by using pressure vessels is therefore a commercially viable option, and potentially a commercially preferable option compared to the transportation of raw natural gas using pipelines, due to the usually long distances involved, and/or the frequently deep waters of the oceans or seas across which the pipelines would then have to extend.

The pressurisation of the natural gas into these vessels might be achievable directly by using the high pressure of the gas as it is found in the natural underground wells. In this case the gas can be directly injected into the vessels from the wells using pipework provided at the drilling rigs. The pressure of the well then provides the required pressure gradient for the loading operation. However, as an alternative, the pressurisation of the natural gas into the vessels can instead be achieved using mechanical compressors. Those compressors can compress the natural gas up to the desired storage pressures, i.e. in the order of 250 bar, as discussed above).

The loading of the CNG into the vessels is preferably a quick process since many vessels will typically be present on a transport vehicle, such as a ship or tanker. As such, quick but reliable and safe loading of CNG into the pressure vessels can therefore greatly contribute to making the transportation of CNG using such vessels more economical—the faster the loading time, the faster the turnaround of the ship. For example, if there are 200 vessels on a ship needing sequential loading, and if each vessel takes 10 minutes to load, then the total turnaround time for the ship will be 33 hours. Cutting the loading time down to 5 minutes would therefore contribute immensely to transportation efficiencies. For this reason, the vessels are loaded by rapidly injecting the natural gas into the vessel, and this, in the initial stages of loading of a vessel, involves allowing the pressurised CNG from a supply line to expand in a quick and uncontrolled manner into the “empty” vessels. This process, known in the art as throttling, involves a quick adiabatic expansion of the natural gas through an inlet of the vessel. However, that rapid expansion of natural gas inside the vessel causes a rapid cooling of the gas, and thus also of the inlet and the area of the vessel surrounding that injection point. This cooling effect is well known and documented in scientific literature, and is often referred to as the “Joule-Thomson” effect, hereinafter the JT effect. This cooling of the natural gas, as caused by its turbulent expansion into the pressure vessels, can be very rapid at the onset of the loading process since the pressure change at that time is at its largest. After all, the “empty” vessel will be at atmospheric pressure, or at least at a pressure much closer to atmospheric than the incoming CNG, whereby the pressure gradient is at a maximum.

As suggested above, the expanding and cooled natural gas will tend to cool the inlet, i.e. the neck of the vessel, plus the internal walls of the vessels surrounding that inlet. They will also cool the rest of the vessel, but without the same degree of ferocity due to the lower proximity of those other parts of the vessel to the point of expansion.

The cooling around the inlet can lead to the material of the vessel being exposed to severely low temperatures, and large temperature gradients across the vessel as a whole. This can be particularly problematic when the outside temperatures are already very cold, i.e. sub zero ° C., as can occur in certain drilling rig locations, or at certain times of the year. The areas of the internal walls of the vessels closest to the inlet (or inlets if more than one is used for loading the CNG) will be particularly exposed to these low temperatures, and will characterise the temperature gradients relative to the more distal areas of the vessel, due to their proximity to the point of expansion, i.e. the area with the most turbulent part of the CNG expansion. Further, because these inlet regions are usually “neck” shaped, such as adopting the shape of the neck of a bottle, the temperature gradients across the vessel wall can lead to stresses and strains in the wall of the vessel—the relatively smaller diameter neck portion will try to contract due to the temperature drop thereof, whereas the surrounding parts will try to contract at differing rates.

Yet further, upon cooling the material, its material properties are changed, usually making the components/walls more brittle. Further, experience in storing and transporting CNG offshore and inshore has demonstrated that repeat cycles of loading and unloading of CNG, and thus repetitive cooling of the vessels through the JT effect resulting therefrom, can cause a gradual deterioration, or potentially even an embrittlement, of the inlet and of the surrounding walls of the vessels, i.e. the areas most exposed to the expanding (and thus cooling) gas, and this can lead to a change in the properties of the material.

In the case of metallic pressure vessels, the lowered strength, or other changed properties, will generally result in reduced tolerance in terms of the acceptability of micro-crackings or other, potentially harsher, defects. After all, they can have the potential to lead to catastrophic failures of the vessels—i.e. explosive bursting of the vessel.

Likewise, metal vessels can also fail simply due to fatigue as a result of the cycling stresses and strains generated by repeated loading and unloading of the vessels, and the colder environment would decrease the fatigue life.

In the case of composite material pressure vessels, the embrittlement issue is less likely to lead to large-scale cracking and a catastrophic failure, although cracking can still occur most likely in the matrix material (usually a polymeric resin), albeit typically leading to micro ruptures, and thus problematic CNG leaks. These failures, however, are all categorised as “JT embrittlement” of the inlet and/or walls of the vessels, and are most commonly first manifested at the internal areas thereof, and are thus seen to be a mechanical failure of the vessel requiring a replacement of that vessel—an expensive process since each vessel is a costly item.

From a mechanical and financial standpoint, therefore, controlling the effect of the JT effect during loading of the vessels can be critical for the structural health and longevity of the vessels, bearing in mind that the existence of the JT effect is an inevitable result of the process of loading CNG pressure vessels.

Given all the problems discussed above, the present invention seeks to reduce the impact of the JT effect on pressure vessels that are used for containment, storage and transportation of CNG. In particular, the present invention aims to reduce the incidence of JT embrittlement of the vessels, whereby there will be a reduction in the number of vessel failures, and also a longer life expectancy for the vessels in the first place.

According to the present invention, there is provided a pressure vessel for storage and transportation of CNG comprising a body defining an internal volume in which the CNG is stored and transported, the body having an inlet through which the CNG can be loaded into the internal volume of the vessel, the inlet comprising a loading appendage extending from its proximal end to its distal free end so as to project inwardly with respect to the internal volume of the vessel. By having the appendage, the gas, upon entering the vessel, will still expand. However, it will cool most rapidly the appendage, rather than the neck and end-wall of the vessel. That appendage, however, can freely expand and contract, and it will not be exposed to external loading forces, since it is spaced away from the neck of the vessel, and it is located internally of the vessel.

Preferably the body of the vessel is generally defined by a cylindrical portion with two caps, and wherein the inlet is located in or on one of the caps.

Preferably at least one of the caps has a domed shape.

Preferably the inlet is located on a domed shape of the vessel, e.g. one of the caps, in a generally axially-symmetric configuration with respect to the domed shape's axis.

Preferably the domed shape has an axial depth, and the extension of the loading appendage is equal to, or approximately equal to, twice the axial depth of the dome.

In another arrangement, the domed shape has an axial depth, and the extension of the loading appendage is equal to, or approximately equal to, one and a half times the axial depth of the dome.

Preferably the loading appendage extends generally along an axis of the vessel. That axis is typically the longitudinal axis of the vessel since the vessel will typically be elongated.

The vessel may be a metal (e.g. steel) vessel or a composite vessel or a hybrid vessel, e.g. both steel and composite.

The vessel may have a length in excess of 2 m, i.e. preferably up to 20 m in length.

The vessel may be generally cylindrical, or it may have a generally cylindrical section, with an external diameter of 1 m or more, e.g. 6 m.

Preferably the loading appendage extends generally through or towards the middle of the vessel.

The loading appendage may have a tapering inner dimension, larger towards its distal free end than at the proximal end.

The loading appendage may formed as a distinct structure with respect to the vessel, and it may be sealingly coupled to the vessel at or in a neck formation or wall opening of the vessel.

The loading appendage may form a cantilevered beam within the vessel.

A proximal end of the appendage may beg constrained at or in a neck formation or wall opening of the vessel.

Preferably the loading appendage is made of metal. Preferably the metal is steel. An alternative arrangement may have the loading appendage made of a polymeric material.

The appendage may be integrally formed as part of the inlet of the vessel. That inlet, together with its appendage, would then form part of the distinct structure mentioned above. Alternatively, however, the inlet and its appendage may both be integrally formed as a part of the vessel.

Preferably the inward extension of the loading appendage is approximately as long as the internal maximum radial dimension of the vessel, with respect to a central or longitudinal axis thereof.

The inward extension of the loading appendage may be longer than the internal maximum radial dimension of the vessel, with respect to a central or longitudinal axis thereof, but shorter than the internal length of that axis.

The appendage has a free end since it does not extend across the full length of the inside of the vessel. As such, the inward extension of the loading appendage may be comprised in the range of between 40% and 80% of the internal, maximum diametrical dimension of the vessel, with respect to a central or longitudinal axis thereof.

Preferably the inlet is circular in shape.

Preferably the loading appendage is generally tubular.

For example, the loading appendage may be cannulated with a single central aperture through its middle, extending from one end to the other.

The loading appendage may comprise multiple apertures extending through its sidewalls.

The distal end of the loading appendage may comprise a diffuser head.

Preferably the diffuser head comprises multiple apertures.

The sum of the cross-sectional areas of the apertures may be approximately equal to, or it may exceed, the minimum internal and open, total, cross-sectional area of the appendage. This insures that the appendage does not further constrict fluid flow unnecessarily prior to its expansion into the vessel.

The sum may be approximately equal to, or it may exceed, the cross sectional area of a circle having a diameter of 12 inches (approx. 30 cm), i.e. the area should be at least 700 cm².

The sum may be approximately equal to, or it may exceed, the cross sectional area of a circle having a diameter of 24 inches (approx. 60 cm), i.e. the area could be at least 2800 cm².

The present invention also provides a method of loading CNG into a pressure vessel comprising the steps of:
providing a pressure vessel having a body defining an internal volume for accommodating the CNG, the pressure vessel having an inlet for loading CNG into the vessel, and wherein the inlet comprises a loading appendage extending from its proximal end to its distal free end so as to project inwardly with respect to the internal volume of the vessel;
providing a high pressure supply line of CNG and coupling said line with said vessel via the inlet; and
filling the container with CNG to a desired final pressure.

The internal volume, prior to the filling step, is typically provided substantially empty of CNG, or only with residual CNG therein, such as at a low pressure relative to the high pressure of the CNG supply line. That pressure, for example, could be atmospheric pressure. Typically, however, that pressure will be elevated slightly above atmospheric pressure since it is unusual, due to time efficiencies, for the vessel to be entirely emptied of CNG.

Preferably the supply line connects to a pressure detector for detecting the pressure within the vessel, and the filling step cuts off via a valve when the desired final pressure, preset within a control mechanism, is detected.

The pressure vessel used in the method will typically be in accordance with the first aspect of the invention.

These and other preferred or optional features of the present invention will now be described in greater detail, purely by way of example, with reference to the accompanying drawings in which:

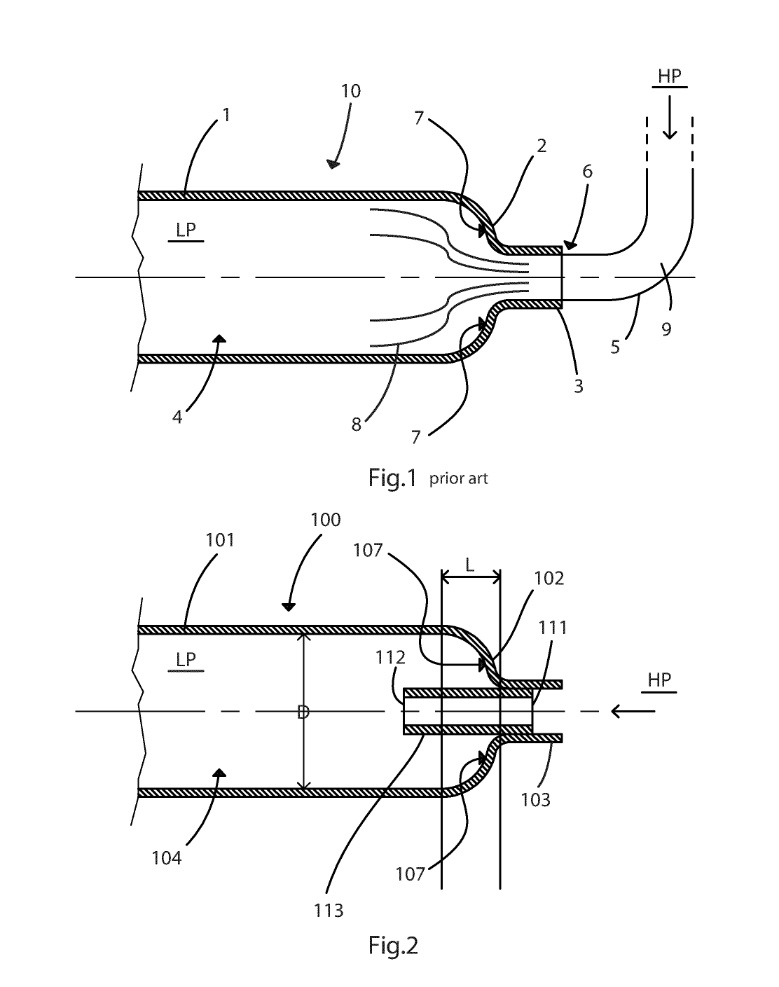

FIG. 1 is a schematic representation of the loading of CNG into a pressure vessel of the prior art, with the pressure vessel shown in partial cross-section;

FIG. 2 is a schematic representation, also in partial cross-section, of a pressure vessel according to the present invention;

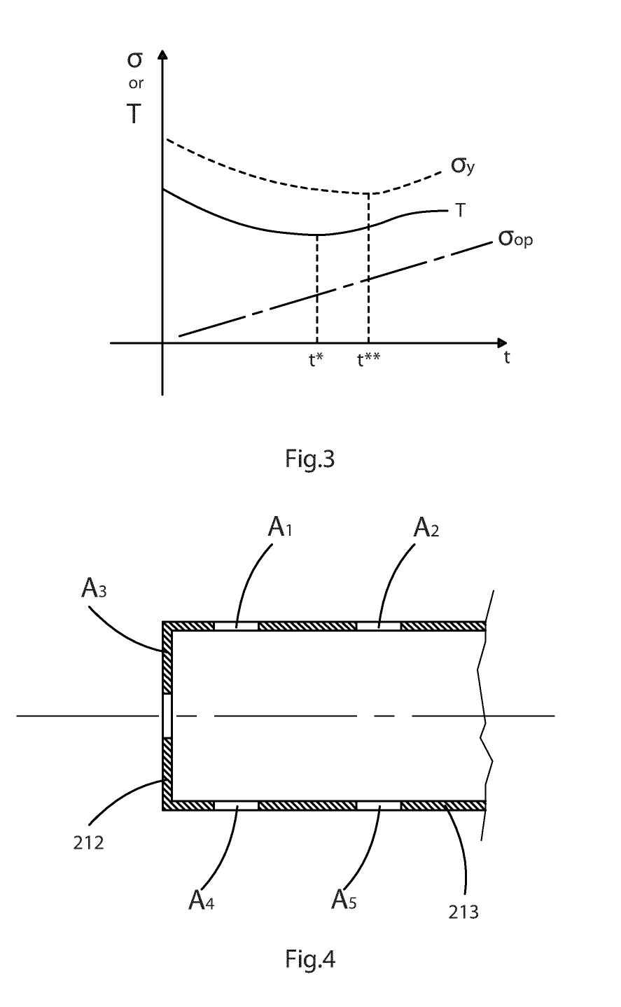

FIG. 3 schematically illustrates a graph for explaining schematically the impact of the JT effect on the mechanical behaviour of CNG pressure vessels; and

FIG. 4 schematically shows a cross-sectional view through an outlet portion of a loading appendage according to the present invention.

As shown in FIGS. 1 and 2, with FIG. 1 being a prior art pressure vessel 10 and FIG. 2 being a pressure vessel 100 modified to be in accordance with the present invention, CNG transportation vessels 10, 100 generally have a cylindrical body 1, 101 with a domed shape end cap 2, 102 on each end thereof (only one end is shown). Those domed shape ends 2, 102 can even be more or less pronounced than that shown, i.e. they can be relatively flat with rounded shoulders, as shown in FIGS. 1 and 2, or they can be relatively cone-shaped with just a gentle main curve and more sharply rounded shoulders (not shown), or they may be rounded into hemi-spherical shapes (not shown).

Within or from those end caps 2, 102 a neck 3, 103 for the vessel 10, 100 is formed. To load the vessels 10, 100, the CNG is injected through the neck 3, 103 into the internal volume of the vessel 10, 100. This injection results in a turbulent expansion 8 of the gas as it enters the vessel 10, 100. The expansion 8 is schematically illustrated in FIG. 1. The expansion causes JT effects, which can lead to JT embrittlement of the fabric of the vessels 10, 100, especially after multiple loading/unloading cycles.

In FIG. 1, the areas of the vessel 10 most exposed to JT embrittlement are located on the inside surface 7 of the end cap 2 that features the gas inlet 6, i.e. at or near the neck 3. The pressure of the vessel 10 prior to loading is the vessel's initial pressure LP. This will typically be a relatively low pressure and it might be as low as the surrounding atmospheric pressure, i.e. nominally 1 bar, such as when the pressure vessel 10 has been substantially emptied of all residual CNG. Typically, however, the initial pressure LP will be higher than that, such as perhaps 30 to 50 bar. That is because residual CNG is left to remain within the vessel 10 after unloading the CNG from the vessel 10.

This can be due to the fact that often it is impractical fully to offload the CNG from a pressure vessel 10, since that would take too long to maintain loading efficiencies. Secondly, by leaving a residual pressure within the vessel 10, the pressure gradient when refilling the vessel from a high pressure CNG source is less severe, thus reducing the severity of the JT effects at least to a certain degree. That residual CNG is therefore commonly left to remain in the vessel 10 even after offloading of the CNG at a delivery or distribution point.

As shown in FIG. 1, loading of CNG commences by coupling a CNG delivery line or pipe 5 to the vessel 10. The coupling is such that a high pressure seal 6 is formed between the delivery pipe 5 and the pressure vessel 10. The CNG 9 delivered through the delivery line will be at a high pressure HP, which may be in the order of hundreds of bar, and it will typically be between 200 and 300 bar.

In many applications, the delivery pressure is set at approximately 250 bar.

Given the pressure gradient between the delivery line 5 and the internal volume 4 of the vessel 10, the CNG 9 expands 8 as it enters into the vessel 10. At the same time, the pressure of the vessel 10 starts to increase. However, the expansion still leads to JT effects.

As discussed above, the internal surface 7 of the end cap 2, plus the neck 3, will be the areas most impacted by the JT effect. To slow the rate of expansion at any given point thereat, it can be seen that the neck 3, as it merges with the end cap 2, tapers outwardly somewhat. This is to allow a slightly more gradual or controlled expansion of the gas, and also to cause it to enter into the relatively unrestricted free space of the inner volume of the vessel at a lower pressure than that of the supply pipe 5. This also delocalises the effect on the JT effect on the walls of the vessel and the neck. Nevertheless, that effect is still most felt around the neck of the vessel, and on the internal surface 7 of the end cap 2.

In the final stages of the loading process, the pressure gradient between the supply pipe and the internal volume of the vessel 10 becomes less significant and the flow of CNG continues until such a time that the vessel is deemed fully loaded. At that point, the supply is cut-off by a valve such that the delivery pipe 5 is closed. Likewise the vessel can be closed in a conventional manner. The delivery pipe 5 can then be disconnected from the vessel 10.

A sensor can be used to determine the pressure within the vessel, and that can be used to determine the optimal cut-off point.

The pressure vessel can then be transported, such that the CNG stored therein becomes downloadable at the required destination.

The procedure can then be repeated, with fresh CNG being reloaded into the emptied vessel 10.

Such loading and unloading cycles will be carried out many times over the life of a pressure vessel—perhaps many hundreds or thousands of times during the lifespan of a vessel. The vessels therefore need to be structurally capable of handling the repeated thermal and mechanical stresses and strains of the loading/unloading procedures. Further, given the fact that the loading and unloading often happens in harsh environments, such as under extreme cold or hot temperatures, such as in deserts or polar environments, and since the vessels are handled rapidly, and thus perhaps without utmost care and attention, they also need to remain tough and capable of suffering such treatment without breaking during the worst of that treatment, especially when the pressure gradient is at its peak, i.e. at the start of loading operations.

To allow the vessel more readily to cope with these extremes, as shown in FIG. 2 the present invention additionally provides a loading appendage 110 within the neck 103 of the vessel 100, the appendage 110 extending into the vessel 100. This appendage helps to mitigate the undesired JT effects of the CNG expansion into the pressure vessel 100.

The loading appendage 110 is provided entirely internally of the vessel 100, with the neck 103 forming part of that vessel 100. The appendage 110 is hosted partly in the neck 103 of the vessel 100, and the rest then extends into the inner volume 104 of the vessel 100.

The nominal outer diameter of the appendage 110 is shown to be constant. Likewise the nominal internal diameter is shown to be constant.

At the neck 103, the nominal diameter of the appendage 110 is approximately the same as the nominal internal diameter of the neck 103 of the vessel 100. With an interference fit, and with appropriate sealing using methods known in the art, the appendage 110 seals with the neck 103. However, other methods of mounting an appendage of this nature to the inside of the vessel are also possible. For example, it could be integrally formed thereat.

The appendage 110 is also shown to be cantilevered in towards the middle of the vessel 100, from the neck 103 of the vessel 100, thereby having a free length extending inside the vessel 100.

The loading appendage 110 is provided in this basic embodiment by a tubular length of pipe. It has a CNG inlet 111 and a CNG outlet 112 for allowing the passage of CNG therethrough.

The inlet 111 is configured at the proximal end of the appendage and it is for being permanently or releasably coupled to a connector for connecting to a CNG delivery line or pipe 5, such as that known in the art. See, for example, FIG. 1.

The free or distal end of the appendage 110, on which the CNG outlet 112 is located, is spaced away from the neck 103 of the vessel 100. As a result it functions to distance the point at which the CNG is released into the internal volume 104 of the vessel 100 from both the neck 103 and the inside surface 107 of the end cap 102 of the vessel—i.e. the end cap that houses the neck (or CNG inlet). The CNG is thus released further inside the vessel 100, whereby the rapid cooling effect on the neck and inside surface 107 is less pronounced. Instead the appendage 110 suffers the worst of that cooling effect. This is a preferred arrangement since that appendage will not cause significant loadings in the sidewalls of the vessel. Likewise it will not be acted upon by external forces.

In this embodiment, the free length of the appendage 110, and the opening at the end thereof, extend axially inward of the vessel. However, different geometries are also possible. It is merely preferred that the appendage 110 allows the CNG to be released into the vessel 100 sufficiently far away from both the neck 103 and the inside surfaces 107 of the vessel 100 for the JT effect on those structurally crucial elements of the vessel 100 to be minimised.

Turning now to dimensional aspects of the loading appendage, it can be seen in FIG. 2 that the free length of the cantilevered loading appendage 110 measures approximately 1.5 times the axial depth L of the end cap 102 of the pressure vessel 100. It might be longer than that, e.g. 2 times the axial length L, or even longer than that.

In other embodiments, the free length of the loading appendage 110 can be measures as a percentage of the internal diameter of the cylindrical body of the vessel, for example about 40% of the internal diameter D of the cylindrical body of the vessel, i.e. it can measure about 10% less than the internal radius of the cylindrical body of the vessel, or as shown, it can be longer—for example, about 60% of the internal diameter as shown, or longer, i.e. longer than the radius.

In a further embodiment, the length may as much as 80% of said internal diameter D.

In preferred arrangements, the free length of the loading appendage insert is between 40% and 80% of the diameter D of the vessel. However, in yet other embodiments, the free length of the loading appendage can be between 10% and 80% of the internal length of the vessel 100—it does not need to extend over the full internal length of the vessel, and is preferably much shorter than the internal length of the vessel, i.e. preferably no more than half of that length, or no more than a quarter of that length.

Because the loading appendage is designed to provide an inlet of gas into the vessel at a point distant enough from the internal walls of the domes of the vessels, it is preferred that the free length of the loading appendage is up to, or equal to, half of the internal diameter D of the vessel (i.e. 50% of D). To make it longer than that would offer minimal additional benefits in terms of taking the end away from walls of the vessel, as explained below, but it would make it require additional material in its fabrication, firstly as a result of its increased length, and secondly to compensate for the increased cantilever forces to which it would then be exposed, e.g. from transportation vibrations. As such, the cost of it would increase.

A reason for the lack of additional benefits in terms of taking the end away from walls of the vessel, is that the additional length would simply retain a consistent closeness to the nearest sidewall of the cylindrical portion of the vessel, whether that length be 50% of the diameter of the vessel or e.g. 60% of that diameter. However, taking it to 50% of the diameter, even with a hemispherical dome for the end 102, does have the benefit of maximising the distance from that free end to the nearest sidewall of the vessel so as no longer to expose any part of the sidewall, or the neck, to the extreme concentrations of the cooling effects arising from the JT effects. In other words, any additional length would serve to take the inlet farther from the neck, but it would not take it any further away from the walls of the cylinder.

Referring now to FIG. 3 of the drawings, the mechanical behaviour of a CNG pressure vessel in response to loading of CNG is described and briefly analysed.

The graph of FIG. 3 illustrates the behaviour of the yield strength of the vessel σ_{y} (or ultimate strength in case of composite structure), the stress generated in the vessel by the increasing internal pressure σₒₚ and the internal temperature in the vessel T as a function of time t.

The internal pressure of the vessels increases as CNG is loaded into the vessels. The stress σₒₚ supported by the vessel's wall increases accordingly. However, as the CNG is loaded into the vessels, the temperature T of the gas initially decreases, due to the JT effect. The temperature T then reaches a minimum at an instant t*. Thereafter the temperature T of the gas within the vessel increases since the JT effect is minimised as the pressure within the vessel increases—there is a smaller pressure gradient.

The temperature of the internal wall of the vessel, which is in contact with the cooled CNG, will likewise decrease during this initial time period, although with some delay due to thermal inertia (the gas will cool faster than the internal wall of the vessel while that temperature is dropping). That temperature drop of the internal wall of the vessel causes the yield (or the ultimate) strength σ_{y} of the vessel's wall likewise to drop (JT embrittlement), and that temperature and yield (or the ultimate) strength σ_{y} will reach a minimum at a time t**. This occurs later than the instant t*. That is because with the gas being cooler than the internal surface of the vessel, even as the gas starts to heat up again it briefly remains cooler than the internal surface of the vessel, whereby the gas will continue to drop the temperature of the walls for that brief period of time. Eventually, however, the gas reaches a temperature at which it exceeds the temperature of the walls, whereupon the walls start to warm up again and the yield strength increases again.

The degree and rate of cooling of the internal portion of the material of the vessel determines the amount of JT embrittlement of the vessel that is likely to occur. In mechanical terms, a JT embrittlement will result in a decrease in the yield (or the ultimate) strength σ_{y} of the material, and this can be an instantaneous effect due to the lower temperature of the vessel, as shown. However, it can also be a cumulative effect, whereby repeated loading and unloading causes the yield (or the ultimate) strength to commence at a lower starting value, and thus also to reach a lower minimum value.

The relationship between σ_{y}, σₒₚ and t** will determine the probability of failure of the vessel due to 1) the loading on the sidewalls due to the pressure of the CNG therein and 2) any JT embrittlement that is occurring. In that regard, it is important to not allow the yield (or the ultimate) strength σ_{y} to drop below the stress σₒₚ supported by the vessel's wall. Too deep a temperature drop in the walls is thus undesirable, and minimising that drop is therefore preferable. That is what the present invention's appendage serves to do—the coolest part of the vessel—the appendage—remains a non-pressure bearing element of the vessel, and the coolest part of the inflowing gas is maintained as far as possible away from the pressure-bearing sidewalls/ends of the vessel.

Finally, FIG. 4 shows a modification for the appendage 213, which allows a longer appendage 213 to be provided, together with a larger overall opening cross-sectional area for allowing a more controlled expansion of the CNG from the high pressure supply pipe.

This embodiment of loading appendage comprises a CNG diffuser head. The diffuser head comprises a plurality of apertures A₁ to A₅. Many such apertures can be provided. Five are shown in this drawing. The apertures are provided to allow the gas to diffuse through multiple apertures rather than expanding from just a single outlet.

In the embodiment of FIG. 4, the apertures of the loading appendage 213 provide the multiple gas outlets, and they can all be located towards a distal end of the appendage, which takes the form of a cantilever beam (it is attached to the end cap of the vessel as before). Again it can be supported in the neck of the vessel, although this is not shown in FIG. 4).

The diffuser head contributes to reducing the impact of the JT effect. This is because the diffuser head will allow the gas to pass through a larger cross-sectional area of opening as it enters the vessel than that of just the cannulation of the appendage. As a result the gas will expand over a larger proportion of the volume of the vessel, whereby the expansion is less point-specific. Nevertheless, the amount of high pressure gas passing through the appendage can be maintained at full throttle to ensure that the gas is loaded as quickly as possible into the vessel.

Further, since the CNG can pass through several openings instead of just one, it expands less turbulently when entering the vessels, and/or with more spread, thereby with the advantage of having a smaller volume of gas passing through each opening, and also hence being less concentrated in its intensity in terms of its direct interaction with specific areas of the walls.

FIG. 4 shows a total of five CNG diffuser apertures located on the distal end of the loading appendage 213. One preferably circular aperture, A3, opens in line with the vessel's longitudinal axis and is located on a wall of the diffuser head that lies perpendicular to said axis. The aperture is shown to be coaxial with the loading appendage and thus it is also preferably coaxial with the vessel. The other four apertures, two on the top side of the diffuser and two on the lower side of the diffuser, as shown, open transversely with respect to such axis.

Further apertures (not shown) may extend in and out of the page.

In FIG. 4, the apertures are disposed symmetrically with respect to the horizontal plane that passing through the axis of the vessel as shown, i.e. each one is disposed in opposition with another, with reference to said plane. This favours an even diffusion, although it is not an essential feature of the invention.

To increase diffusion of the CNG upon loading, a criterion can be followed for sizing the apertures: The sum of the cross-sectional areas of the apertures should be greater than an area of a cross section of the aperture extending through the neck of the vessel (or through the appendage if smaller).

In this embodiment, the neck of the vessel provides an aperture of 18 inches (about 45 cm), and the sum of the areas is greater than or approximately equals the area of a circle having a diameter of about 18 inches (about 45 cm), i.e. the area of the gas inlet through the neck of the vessel.

Another preferred nominal diameter for the inlet neck of CNG pressure vessels is 24 inches (about 60 cm). The same criterion for sizing the apertures could apply: the sum of the areas of the open surfaces could equal or exceed the area of a circle having a diameter of about 24 inches (about 60 cm).

Given its function, the loading appendage may be fabricated with different materials. An example of material that can be used for the appendage is a metal, in particular a metal that is already approved by the relevant ISO standards for use in CNG applications, like certain grades of carbon steel. However, these loading appendices could be made of aluminium, which is lighter than steel and has good corrosion resistance. Carbon steel would be preferred if the cost is to be kept low. Polymeric or reinforced polymeric materials are also viable for the loading appendices, these materials generally being corrosion proof, and cheaper and lighter than metals. They also require now welding, and they can be compliant for easier assembly. Because of their lightness, polymeric or reinforced polymeric materials may also be longer without causing excessive cantilever forces, especially when maintained, in use, in horizontal conditions.

The pressure vessels using this invention may be able to carry a variety of gases, such as raw gas straight from a bore well, including raw natural gas, e.g. when compressed—raw CNG or RCNG, or H₂, or CO₂ or processed natural gas (methane), or raw or part processed natural gas, e.g. with CO₂ allowances of up to 14% molar, H₂S allowances of up to 1,000 ppm, or H₂ and CO₂ gas impurities, or other impurities or corrosive species. The preferred use, however, is CNG transportation, be that raw CNG, part processed CNG or clean CNG—processed to a standard deliverable to the end user, e.g. commercial, industrial or residential.

CNG can include various potential component parts in a variable mixture of ratios, some in their gas phase and others in a liquid phase, or a mix of both. Those component parts will typically comprise one or more of the following compounds: C₂H₆, C₃H₈, C₄H₁₀, C₅H₁₂, C₆H₁₄, C₇H₁₆, C₅H₁₈, C₉+ hydrocarbons, CO₂ and H₂S, plus potentially toluene, diesel and octane in a liquid state, and other impurities/species.

The present invention has been described above purely by way of example. Modifications in detail may be made to the invention within the scope of the claims appended hereto.

1. A pressure vessel for storage and transportation of CNG comprising a body defining an internal volume in which the CNG is stored and transported, the body having an inlet through which the CNG can be loaded into the internal volume of the vessel, the inlet comprising a loading appendage extending from its proximal end to its distal free end so as to project inwardly with respect to the internal volume of the vessel.

2. A pressure vessel according to claim 1, wherein the body of the vessel is generally defined by a cylindrical portion with two caps, and wherein the inlet is located in or on one of the caps.

3. A pressure vessel according to claim 3, wherein at least one of the caps has a domed shape.

4. A pressure vessel according to any one of the preceding claims, wherein the inlet is located on a domed shape of the vessel in a generally axially-symmetric configuration with respect to the domed shape's axis.

5. A pressure vessel according to claim 3 or claim 4, wherein the domed shape has an axial depth, and the extension of the loading appendage is equal to, or approximately equal to, twice the axial depth of the dome.

6. A pressure vessel according to claim 3 or claim 4, wherein the domed shape has an axial depth, and the extension of the loading appendage is equal to, or approximately equal to, one and a half times the axial depth of the dome.

7. A pressure vessel according to any one of the preceding claims, wherein the loading appendage extends generally along an axis of the vessel.

8. A pressure vessel according to any one of the preceding claims, wherein the loading appendage extends generally through or towards the middle of the vessel.

9. A pressure vessel according to any one of the preceding claims, wherein the loading appendage has a tapering inner dimension, larger towards its distal free end than at the proximal end.

10. A pressure vessel according to any one of the preceding claims, wherein the loading appendage is formed as a distinct structure with respect to the vessel, and is sealingly coupled to the vessel at or in a neck formation or wall opening of the vessel.

11. A pressure vessel according to any one of the preceding claims, wherein the loading appendage forms a cantilevered beam within the vessel, a proximal end thereof being constrained at or in a neck formation or wall opening of the vessel.

12. A pressure vessel according to any one of the preceding claims, wherein the loading appendage is made of metal.

13. A pressure vessel according to claim 12, wherein the metal is steel.

14. A pressure vessel according to any one of claims 1 to 11, wherein the loading appendage is made of a polymeric material.

15. A pressure vessel according to any one of the preceding claims, wherein the appendage is integrally formed as part of the inlet of the vessel.

16. A pressure vessel according to any one of the preceding claims, wherein the inward extension of the loading appendage is approximately as long as the internal maximum radial dimension of the vessel, with respect to a central or longitudinal axis thereof.

17. A pressure vessel according to any one of claims 1 to 15, wherein the inward extension of the loading appendage is longer than the internal maximum radial dimension of the vessel, with respect to a central or longitudinal axis thereof, but shorter than the internal length of that axis.

18. A pressure vessel according to any one of claims 1 to 15, wherein the inward extension of the loading appendage is comprised in the range of between 40% and 80% of the internal, maximum diametrical dimension of the vessel, with respect to a central or longitudinal axis thereof.

19. A pressure vessel according to any one of the preceding claims, wherein the inlet is circular in shape.

20. A pressure vessel according to any one of the preceding claims, wherein the loading appendage is generally tubular.

21. A pressure vessel according to any one of the preceding claims, wherein the loading appendage is cannulated with a single central aperture.

22. A pressure vessel according to any one of the preceding claims, wherein the loading appendage comprises multiple apertures extending through its sidewalls.

23. A pressure vessel according to any one of the preceding claims, wherein the distal end of the loading appendage comprises a diffuser head.

24. A pressure vessel according to claim 21, wherein the diffuser head comprises multiple apertures.

25. A pressure vessel according to claim 22 or 24, wherein the sum of the cross-sectional areas of the apertures is equal to, or exceeds, the minimum internal and open, total, cross-sectional area of the appendage.

26. A pressure vessel according to claim 25, wherein the sum is equal to or exceeds the cross sectional area of a circle having a diameter of 12 inches (approx. 30 cm).

27. A pressure vessel according to claim 25, wherein the sum is equal to or exceeds the cross sectional area of a circle having a diameter of 24 inches (approx. 60 cm).

28. A pressure vessel substantially as hereinbefore described with reference to any one or more of FIGS. 2 to 4.

29. A method of loading CNG into a pressure vessel comprising the steps of:
providing a pressure vessel having a body defining an internal volume for accommodating the CNG, the pressure vessel having an inlet for loading CNG into the vessel, and wherein the inlet comprises a loading appendage extending from its proximal end to its distal free end so as to project inwardly with respect to the internal volume of the vessel;
providing a high pressure supply line of CNG and coupling said line with said vessel via the inlet; and
filling the container with CNG to a desired final pressure.

30. The method of claim 29, wherein the internal volume, prior to the filling step, is provided substantially empty of CNG, or with residual CNG at a low pressure relative to the high pressure of the CNG supply line.

31. The method of claim 29 or claim 30, wherein the supply line connects to a pressure detector for detecting the pressure within the vessel, and the filling step cuts off via a valve when the desired final pressure, preset within a control mechanism, is detected.

32. The method of claim 29, claim 30 or claim 31, wherein the pressure vessel is in accordance with any one of claims 1 to 28.

33. A method of loading CNG into a pressure vessel substantially as hereinbefore described with reference to any one or more of FIGS. 2 to 4.

34. A loading appendage for a CNG pressure vessel substantially as hereinbefore described with reference to any one or more of FIGS. 2 to 4.

35. A ship comprising at least one pressure vessel according to any one of claims 1 to 28.
